(19) United States
(12) Patent Application Publication
(10) Pub. No.: US 2016/0292714 A1
(43) Pub. Date: Oct. 6, 2016

(54) EVENLY PRESENTING CONTENT ITEMS FROM A CAMPAIGN OVER A TIME INTERVAL BY MODIFYING BID AMOUNTS ASSOCIATED WITH THE CONTENT ITEMS

(71) Applicant: Facebook, Inc., Menlo Park, CA (US)

(72) Inventors: Anand Sumatilal Bhalgat, Mountain View, CA (US); Chinmay Deepak Karande, Mountain View, CA (US); Tanmoy Chakraborty, San Mateo, CA (US)

(21) Appl. No.: 14/678,897

(22) Filed: Apr. 3, 2015

(51) Int. Cl. G06Q 30/02

(52) U.S. Cl. CPC G06Q 30/0242

(57) ABSTRACT

For an advertisement (“ad”) campaign including multiple ad requests, an advertiser may request presentation of a variety of ad requests in the ad campaign as well as specify an objective to be completed by the ad campaign during a time interval and subject to a budget. An online system presenting advertisement content may modify bid amounts associated with ad requests in the ad campaign using advertisement-specific bid adjustment values to select a more diverse range of ad requests from the ad campaign. To satisfy the objective without exceeding the budget, the online system also applies a pacing multiplier to bid amounts of ad requests selected from the ad campaign. As ad requests from the ad campaign are presented, the online system modifies the ad request-specific bid amounts and the pacing multiplier at different rates.

### BACKGROUND

This disclosure relates generally presenting content via online systems, and more specifically to modifying bid amounts associated with content items in a campaign to evenly present the content items during a time interval.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities to increase awareness about products or services by presenting content items to online system users.

Presenting content items to online system users allows an entity to gain public attention for products or services or to persuade online users to take an action regarding the entity's products or services. Additionally, many online systems generate revenue by displaying certain content items to their users. Frequently, online systems charge entities for each presentation of certain types of content items to an online system user (e.g., each “impression” of the certain types of content items) or for each interaction with certain types of content items by an online system user.

Conventionally, an entity provides a campaign to an online system including multiple content items that each present different content to online system users. An online system selects content items from the campaign based on performance or expected performance of the content items when presented to online system users (e.g., prior interaction or expected interaction by social networking system users with the content items). However, this often causes the online system to continually select content items with a threshold performance from the campaign, which may prevent selection of other content items in the campaign that have received a limited amount of user interaction.

### SUMMARY

An online system, such as a social networking system, receives information describing an advertisement campaign (“ad campaign”) including advertisement requests (“ad requests”) from an advertiser for presentation to users of the online system. Each ad request includes an ad creative, or “advertisement,” that identifies content presented to an online system user when the ad request is presented. The information describing the ad campaign specifies a budget for the ad campaign that specifies an amount of compensation the advertiser will provide the online system for presenting ad requests included in the ad campaign and an objective for the ad campaign specifying a goal for presentation of ad requests in the online system to online system users. Additionally, the information describing the ad requests includes information for determining bid amounts associated with ad requests included in the ad campaign. A bid amount associated with an ad request specifies an amount of compensation received by the online system for presentation of the ad request. In some embodiment, the information for determining bid amounts of various ad requests includes instructions for allocating the budget among ad requests in the ad campaign based at least in part on prior interaction with various ad requests, the objective of the ad campaign, and a time interval for completing the objective.

In some embodiments, the objective associated with the ad campaign specifies a number of interactions with ad requests from the ad campaign in a time interval. For example, the objective specifies a total number of impressions of ad requests in the ad campaign during the time interval. However, the objective may also specify a number of another type of interaction with ad requests in the ad campaign during the time interval. Example types of interactions specified by the objective include accesses of ad requests (e.g., clicking on ad requests) in the ad campaign, accessing objects associated with ad requests in the ad campaign, purchasing items associated with ad requests in the ad campaign after being presented with the ad requests, or any other suitable interaction. The online system identifies the objective associated with the ad campaign from the information describing the ad campaign.

To increase the diversity of ad requests from the ad campaign presented to online system users, the online system modifies bid amounts of ad requests in the ad campaign using bid adjustments that are specific to different ad requests. A bid adjustment is specific to an ad request and is determined at least in part on interaction with the ad request by users of the online system presented with the ad request. In one embodiment, the bid adjustment value associated with an ad request (also referred to as an “ad request-specific bid adjustment”) is determined based on any suitable interactions with the ad request when it is presented or information describing presentation of the ad request to users of the online system so the bid ad adjustment value has less effect on an bid amount associated with the ad request as interaction with the ad request increases. Thus, a bid adjustment value for an ad request is inversely proportional to a number of impressions of or a number of interactions with the ad request in various embodiments.

The online system also determines a pacing multiplier associated with the ad campaign based at least in part on a number of users of the online system previously presented with at least one ad request included in the ad campaign, or a number of interactions with ad requests previously presented to online system users, the budget for the ad campaign, and the objective for the ad campaign. In various embodiments, the online system determines bid amounts for ad requests in the ad campaign using the pacing multiplier or modifies bid amounts of ad requests in the ad campaign using the pacing multiplier. For example, the online system determines the pacing multiplier based on prior interactions with or impressions of the ad requests in the ad campaign, the objective of the ad campaign, and the budget of the ad campaign so the budget is allocated among ad requests during a time interval associated with the objective to complete the objective during the time interval. Hence, the pacing multiplier allows the advertiser associated with the ad campaign to allocate the ad campaign's budget among ad requests included in the ad campaign to complete the ad campaign's objective during a time interval.

The online system adjusts bid amounts of ad requests included in the ad campaign based on their corresponding bid adjustments and selects ad requests from the ad campaign based on the adjusted bid amounts. For example, the bid amount of an ad request is adjusted by a bid adjustment specific to the ad request by combining the bid amount and the bid adjustment via any suitable mathematical operation. When an opportunity to present advertisement content to a user of the online system is identified, the online system identifies one or more of the ad requests from the ad campaign based on the adjusted bid amounts associated with the ad requests in the ad campaign For example, the online system ranks ad requests eligible for presentation to the user in the ad campaign (e.g., ad request having at least a threshold number of targeting criteria satisfied by characteristics of the user) based on their adjusted bid amounts and identifies ad requests from the ad campaign having at least a threshold position in the ranking. Identifying ad requests from the ad campaign based on their adjusted bid amounts allows the bid adjustments to influence the ad requests identified from the campaign, allowing a broader range of ad requests to be identified.

Adjusted bid amounts associated with the identified ad requests from the ad campaign are modified using pacing multiplier associated with the ad campaign. An adjusted bid amount may be modified by combining the adjusted bid amount and the pacing multiplier using any suitable mathematical operation including the adjusted bid amount and pacing multiplier. For example, the adjusted bid amount is scaled by the pacing multiplier to increase or decrease the adjusted bid amount. Applying the pacing modifier to the adjusted bid amounts of ad requests identified from the ad campaign allows the online system to regulate the amount of compensation received from the advertiser during a time interval associated with the ad campaign. Hence, the pacing multiplier allows the advertiser to distribute the ad campaign's budget over a time interval.

The online system includes the identified one or more ad requests and their modified adjusted bid amounts in a selection process that selects content for presentation to the user during the identified opportunity. In various embodiments, the selection process ranks the identified ad requests based on their modified adjusted bid amounts along with bid amounts associated with bid amounts of ad requests from other ad campaigns and selects ad requests having at least a threshold position in the ranking. Alternatively, the selection process selects identified ad requests or other ad requests having a modified adjusted bid amount or having a bid amount equaling or exceeding a threshold value for presentation.

If an identified ad request is selected for presentation, the online system communicates the identified ad request to a client device for presentation to the user. Based at least in part on the selection of the identified ad request the online system modifies the pacing multiplier or one or more of the bid adjustments. In various embodiments, the online system modifies the pacing multiplier to account for presentation of the identified ad request from the ad campaign, so bid amounts of ad requests from the ad campaign are subsequently modified to allow completion of the objective of the ad campaign during the time interval. For example, the online system modifies the pacing multiplier based on the objective of the ad campaign, the remaining time interval to complete the objective, the amount of budget remaining to complete the objective, and the number of impressions of ad request from the ad campaign accounting for presentation of the identified ad request. Similarly, the online system modifies the bid adjustment of the identified ad request, or the bid adjustments associated with additional ad requests in the ad campaign, based on presentation of the identified ad request or interaction with the identified ad request. The online system modifies the pacing multiplier and the bid adjustments at different rates based on presentation of ad requests in the ad campaign to online system users, which allows the online system to more evenly present different ad requests from the ad campaign while also satisfying the objective of the ad request given the budget associated with the ad request.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for modifying a pacing multiplier and one or more bid adjustments associated with an ad campaign to present a variety of ad requests from the ad campaign and satisfy an objective of the ad campaign, in accordance with an embodiment.

FIG. 4 illustrates a process flow diagram of modifying bid amounts of advertisement requests in an advertisement campaign based on selection of the advertisement requests for presentation to online system users, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

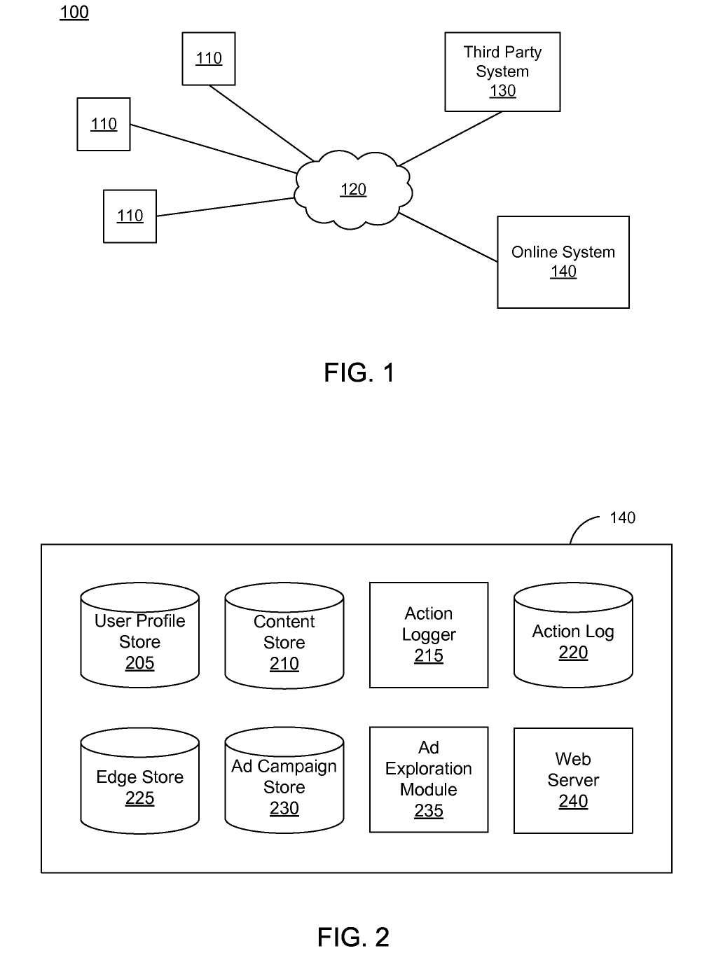

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is asocial networking system; however, the online system 140 may be any suitable system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) campaign store 230, an ad exploration module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture. In various embodiments, the functionality described below may be adapted for use online systems other than an online system 140.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the online system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic or in another user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement campaigns (“ad campaigns”) are included in the ad campaign store 230. An ad campaign includes a plurality of advertisement requests (“ad requests”) received from an advertiser for presentation to users of the online system 140. Each ad request includes an advertisement creative (“ad creative”), which is content presented to an online system user. Examples of an ad creative include text data, image data, audio data, video data, or any other suitable data. An ad request may also associate a destination address with an ad creative to specify a source of content presented to a user who accesses the ad request when it is presented. For example, the destination address identifies a landing page including content that is presented to the user when the user accesses the ad request.

Additionally, ad requests in an ad campaign may be associated with a bid amount provided by the advertiser that provided the ad campaign. A bid amount associated with an ad request specifies an amount of compensation an advertiser provides the online system 140 for presenting the ad request, for a user interacting with the ad request, or for another suitable interaction with the ad request by a user. In some embodiments, the advertiser specifies bid amounts for a subset of the ad requests in the ad campaign and a budget for the ad campaign specifying a maximum amount the advertiser will provide to the online system 140 for presenting ad requests in the ad campaign and the online system 140 determines bid amounts for other ad requests in the ad campaign that are not associated with bid amounts. Alternatively, the advertiser specifies the budget for the ad campaign and a time interval for the ad campaign that specifies a time interval during which ad requests from the ad campaign are presented and the online system 140 determines bid amounts associated with ad requests in the ad campaign based on the budget and the time interval.

In some embodiments, targeting criteria may be associated with the ad campaign in its entirety, so multiple advertisements in the ad campaign are associated with the targeting criteria. Additionally, an advertiser may specify targeting criteria associated with various individual ad requests in the ad campaign to associate different targeting criteria with various ad requests. Targeting criteria associated with an ad request specify one or more characteristics of users eligible to be presented with an ad creative included in the ad request. Associating different targeting criteria with different ad requests in the ad campaign allows an advertiser to tailor presentation of ad creatives to users having specific characteristics, allowing different ad creatives to be presented to users with different characteristics. For example, targeting criteria specify demographic information, connections, or actions associated with a user. In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third party system 130, or any other suitable action. Including actions in targeting criteria allows advertisers to further refine users eligible to be presented with ad requests from an ad campaign. As another example, targeting criteria identifies users having a connection to another user or object or having a particular type of connection to another user or object.

Additionally, the ad campaign may include an objective specifying a goal of the advertiser for presentation of ad requests in the ad campaign to social networking system users. For example, the objective identifies a type of interaction with ad requests included in the ad campaign or with one or more objects associated with ad requests in the ad campaign by social networking system users presented with an ad creative included in an ad request from the ad campaign. Examples of objectives include: social networking system users accessing a presented ad creative (e.g., clicking or otherwise accessing the advertisement), social networking system users installing an application associated with a presented ad request, social networking system users expressing a preference for a page associated with an ad request (i.e., “liking” the page), social networking system users viewing a page associated with the ad campaign, or any other suitable action by social networking system users. In one embodiment, the objective is selected from a set of objectives maintained by the social networking system 140.

Additional information may be included in the ad campaign. For example, the ad campaign includes a budget that specifies a total amount of compensation an advertiser provides the social networking system 140 for presenting ad requests included in the ad campaign. The budget may be allocated for the ad campaign as a whole or per ad request. In addition, the advertiser may specify instructions for allocating the budget among the ad requests in the ad campaign. For example, the instructions specify modification of a bid amount associated with an ad request included in the ad campaign based on an amount of the budget that remains and characteristics of the ad request (e.g., a number of impressions of the ad request that have occurred, a number of a specific type of interaction with the ad request that have occurred). The instructions may also include other suitable information describing allocation of budget among ad requests included in the ad campaign.

In some embodiments, the ad campaign also includes information for determining or modifying bid amounts associated with ad requests in the ad campaign. For example, the ad campaign includes instructions for modifying a pacing multiplier that is applied to bid amounts of ad requests in the ad campaign to increase or to decrease the bid amounts. If the ad campaign is associated with an objective specifying a number of impressions or a number of another type of interaction, the pacing multiplier is determined based at least in part on a time interval for the objective, a number of impressions or other interactions with ad requests from the ad campaign, and a budget for the ad campaign. The pacing multiplier is modified as impressions of or interactions with ad requests in the ad campaign occur, allowing the bid amounts of ad requests in the ad campaign to be modified so the objective of the ad campaign is satisfied when the time interval lapses. Budget-based advertisement bidding using pacing multipliers is further described in U.S. patent application Ser. No. 13/294,094, filed on Nov. 10, 2011, which is hereby incorporated by reference in its entirety.

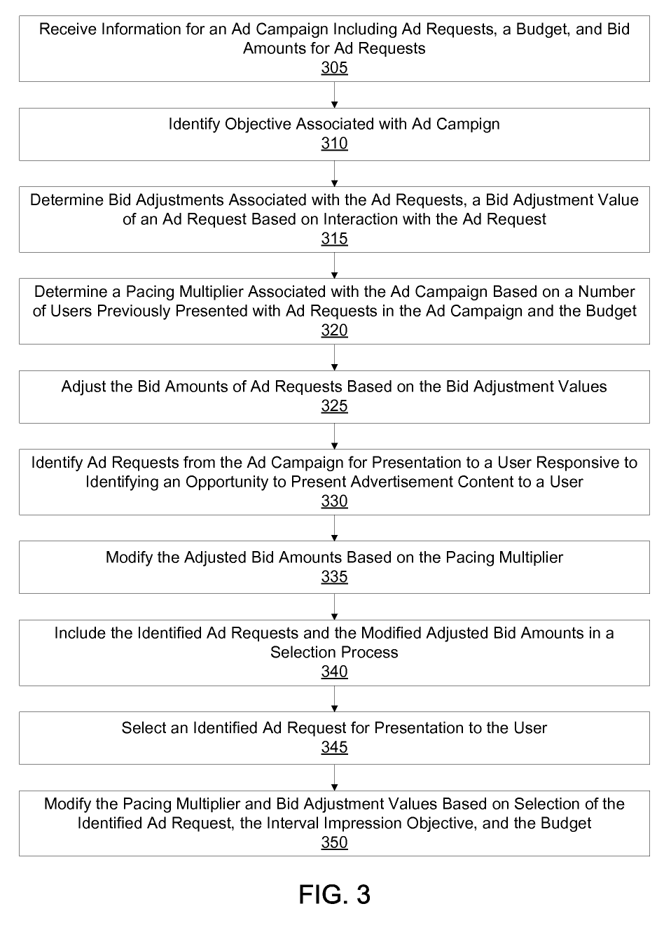

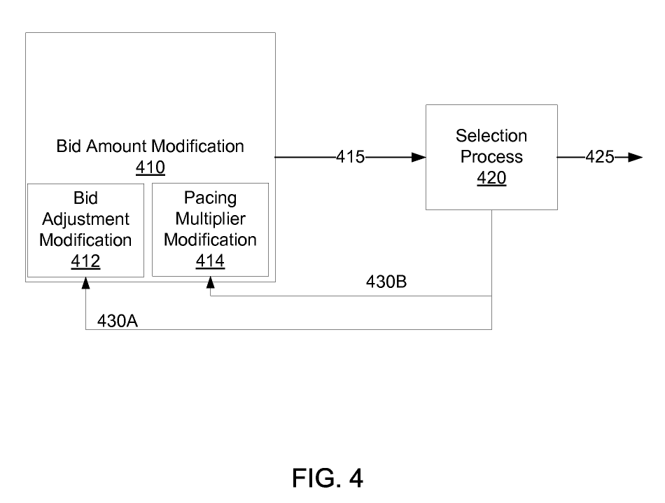

When the online system 140 receives an ad campaign including ad requests, the ad exploration module 235 determines bid adjustments for one or more ad requests in the ad campaign and modifies a pacing multiplier associated with the ad campaign. Based on the bid adjustment for an ad request, the ad exploration module adjusts the bid amount associated with the ad request and selects one or more ad requests from the ad campaign based on the adjusted bid amounts. The ad exploration module 235 modifies the adjusted bid amounts of the selected ad requests based on the pacing multiplier associated with the ad campaign and communicates the selected and requests along with their modified and adjusted bid amounts to a selection process. For example, the ad exploration module 235 identifies ad requests from an ad campaign associated with targeting criteria satisfied by one or more characteristics of a user and determines bid adjustments of the identified ad requests. The ad requests may be identified based on information in the user's user profile stored in the user profile store 205, actions in the action log 220 associated with the user, connections in the edge store 225 associated with the user, or other information associated with the user. The ad exploration module 235 adjusts the bid amounts of the identified ad requests using the bid adjustment values determined for the identified ad request and selects one or more of the identified ad requests based on the adjusted bid amounts, as further described below in conjunction with FIG. 3. The adjusted bid amounts of the identified ad requests that are selected are modified by the pacing multiplier prior to including the selected identified ad requests in a selection process, as further described below in conjunction with FIG. 3. As ad requests from the ad campaign are presented to users or as users interact with ad request from the ad campaign, the ad exploration module 235 modifies the bid adjustments for various ad requests and the pacing multiplier associated with the ad campaign, as further described below in conjunction with FIGS. 3 and 4.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Evenly Presenting Various Ad Requests from an Ad Campaign During a Time Interval

FIG. 3 is a flowchart of one embodiment of a method for modifying a pacing multiplier and one or more bid adjustments associated with an ad campaign to present a variety of ad requests from the ad campaign and satisfy an objective of the ad campaign. In various embodiments, the steps described in conjunction with FIG. 3 may be performed in different orders. Additionally, in some embodiments, the method may include different and/or additional steps than those shown in FIG. 3.

The online system 140 receives 305 information for an ad campaign including one or more advertisement (“ad”) requests for presentation to one or more users of the online system 140. The information specifies a budget for the ad campaign and an objective for the ad campaign that specifies a goal for presentation of ad requests from the ad campaign. Example objectives include a number of impressions of ad requests in the ad campaign or a number of a specific type of interaction and bid amounts associated with one or more of the ad requests included in the ad campaign. As previously discussed in conjunction with FIG. 2, the budget specifies an amount of compensation received by the online system 140 for presenting ad requests in the advertisement campaign. Additionally, the information for the ad campaign includes bid amounts associated with one or more ad requests in the ad campaign or instructions for determining bid amounts for ad requests in the ad campaign. For example, the information includes instructions for allocating the budget among ad requests in the ad campaign based on one or more criteria (e.g., an amount of the budget remaining, an amount of the objective that has been completed, an amount of a time interval of the ad campaign remaining)

As described above in conjunction with FIG. 2, ad requests in the ad campaign include a creative specifying content for presentation to online system users and may be associated with one or more targeting criteria. One or more of the ad requests included in the ad campaign may be associated with less than a threshold amount of interaction by online system users. For example, an ad request may have been presented to less than a threshold number of online system users or may have received less than a threshold number of interactions from online system users presented with the ad request.

The objective associated with the ad campaign is identified 310 by the online system. For example, the objective specifies a number of impressions for various ad requests included in the ad campaign during a time interval. As another example, the objective specifies a total number of impressions of ad requests in the ad campaign during the time interval. In some embodiments, the objective specifies a number of any suitable type of interaction by online system users with ad requests from the ad campaign (e.g., a number of accesses of ad requests from the ad campaign by online system users, a number of interactions with objects associated with at least one ad request from the ad campaign, etc.) during a time interval. Hence, the objective specifies a number of interactions associated with ad requests from the ad campaign during a time interval. If the information describing the ad campaign does not include an objective, the online system 140 may identify 310 an objective associated with the ad campaign by requesting an objective from the advertiser or by inferring an objective based on a number or percentage of characteristics of the ad campaign matching other ad campaigns associated with the advertiser having an objective and inferring the objective as an objective associated with at least a threshold number of other ad campaigns associated with the advertiser having at least a threshold number or percentage of characteristics matching characteristics of the ad campaign.

Based on interactions with various ad requests in the ad campaign by online system users previously presented with the ad requests, the online system 140 determines 315 bid adjustments associated with different ad requests included in the ad campaign. Different bid adjustments are specific to different ad requests, so a bid adjustment for an ad request is based at least in part on interaction with the ad request by users of the online system 140 previously presented with the ad request. In one embodiment, the bid adjustment associated with an ad request is determined 315 based at least in part on a number of impressions of the ad request to online system users. However, in other embodiments, the bid adjustment for an ad request is determined 315 based at least in part on a number of one or more types of interactions with the ad request by online system users (e.g., accesses of the ad request, sharing the ad request with another online system user, interacting with an object associated with the ad request). A bid adjustment for an ad request may be determined 315 so an effect of the bid adjustment on a bid amount of the ad request decreases as an amount of interaction (e.g., a number of interactions with the ad request, a number of impressions of the ad request) increases. For example, a bid adjustment for an ad request is inversely proportional to a number of impressions associated with the ad request and/or to a number of interactions with the ad request. In one embodiment, a bid adjustment value for an ad request A, “γ(A),” is determined 315 as follows:

γ(A)=1+ε (1),

where ε is a function of a number of impressions associated with ad request A and a number of interactions with ad request A. In one embodiment, ε is determined as follows:

$$ɛ = \frac{{C}_{o}}{\sqrt{clicks ( A )}} + \frac{{D}_{o}}{\sqrt{imps ( A )}} , \qquad ( 2 )$$

where clicks(A) is a number of one or more specific types of interactions with ad request A, imps(A) is a number of impressions of ad request A, and Cₒ and Dₒ are constant values. In this embodiment, the bid adjustment for ad request A is determined 315 as:

$$γ ( A ) = 1 + \frac{{C}_{o}}{\sqrt{clicks ( A )}} + \frac{{D}_{o}}{\sqrt{imps ( A )}} . \qquad ( 3 )$$

The values of constants Cₒ and Dₒ may be determined by the advertiser or by the online system 140 so that a number of a specific type of interaction associated with ad request A or a number of impressions associated with ad requests A unequally adjust the ad request-specific bid adjustment. Alternatively, the values of the constants Cₒ and Dₒ are determined so the number or the specific type of interaction associated with an ad request and the number of impressions of the ad request equally influence the ad request-specific bid adjustment for the ad request. In alternative embodiments, the bid adjustment for an ad request may be a weight, a percentage, multiple, or any other suitable factor for combination with a bid amount of the ad request via a mathematical operation that is adjusted over time by the online system 140 based on interactions with the ad request by online system users.

Additionally, the online system 140 determines 320 a pacing multiplier associated with the ad campaign based at least in part on a number of users of the online system 140 previously presented with at least one ad request included in the ad campaign, the budget for the ad campaign, and the objective associated with the ad campaign. The pacing multiplier modifies bid amounts of ad requests included in the ad campaign so the budget of the ad campaign is consumed throughout a time interval associated with the objective so the objective is completed during the time interval. For example, if the ad campaign is associated with an objective specifying a number of impressions during the time interval, the pacing multiplier is determined to modify bid amounts of ad requests in the ad campaign to consume the budget over the time interval so the objective is completed when the time interval ends. Other interactions may be specified by the objective, with the pacing multiplier used to modify bid amounts of ad requests in an ad campaign to satisfy the objective over a specified time interval without exceeding the budget of the ad request. As further described below, the pacing multiplier is modified as online system users are presented with ad requests from the ad campaign or interact with the ad request to more accurately modify bid amounts of ad requests to satisfy the objective associated with the ad campaign. Determination and use of pacing multipliers is further described in U.S. patent application Ser. No. 13/294,094, filed on Nov. 10, 2011, which is hereby incorporated by reference in its entirety.

Bid amounts of ad requests included in the ad campaign are adjusted 325 based on the bid adjustments corresponding to various ad requests. Hence, a bid amount of an ad request is modified by a bid adjustment corresponding to the ad request. The bid amount of an ad request is combined with a bid adjustment corresponding to ad request to adjust 325 the ad request's bid amount. For example, the online system 140 adds or subtracts the ad request's bid adjustment from the ad request's bid amount. In other embodiments, the online system 140 scales the ad request's bid amount by a value based at least in part on the ad request's bid adjustment. For example, a bid amount of an ad request is multiplied by a bid adjustment of the ad request to modify 325 the bid amount of the ad request.

In response to identifying an opportunity to present advertisement content to a user of the online system 140, the online system 140 identifies 330 one or more ad requests from the ad campaign for presentation to a user. For example, the online system 140 receives a request for advertisement content from a client device 110 associated with the user and identifies 330 one or more ad requests from the ad campaign in response to receiving the request. The online system 140 may receive the request for advertisement content when the user views or interacts with at least a threshold number of ad requests via the client device 110, when the client device 110 receives a specific type of interaction from a user, when a threshold number of content items are presented to the user via the client device 110, or when at least a threshold amount of time lapses between a current time and a time when the user was presented with advertisement content.

In some embodiments, the request to present advertisement content to the user includes information describing the user to be presented with the ad request (e.g., a user identifier or other information describing the user) or information describing the context in which an ad request is to be presented (e.g., a type of the client device 110, additional content presented by the client device 110 along with the ad request, etc.). Alternatively, the online system 140 identifies the opportunity to present ad content to the user based on actions from the action log 220 associated with the user, based on receiving a request to log into the online system 140 from the user, or based on any other suitable information. An opportunity to present advertisement content to the user may also be identified when a number of ad campaigns in the ad campaign store 230 exceeds a threshold number of ad campaigns or if at least a threshold number of ad requests are included in the ad campaign.

The online system identifies 330 one or more ad requests from the ad campaign based on the adjusted bid amounts associated with ad requests in the ad campaign. For example, the online system 140 identifies ad requests eligible for presentation to the user (e.g., ad requests including at least a threshold number of targeting criteria satisfied by characteristics of the user, such as interactions associated with the user, demographic information associated with the user, or connections between the user and additional users or objects). The online system 140 may rank ad requests from the ad campaign eligible for presentation to the user based on their adjusted bid amounts and identify 330 ad requests having at least a threshold position in the ranking Alternatively, the online system 140 identifies 330 ad requests from the ad campaign eligible for presentation to the user and having at least a threshold adjusted bid amount. Prior presentation of ad requests in the ad campaign to online system users may also be used when identifying 330 the one or more ad requests. For example, if multiple ad requests have similar adjusted bid amounts, the online system 140 identifies 330 one or more ad requests that have not previously been presented to online system users a threshold number of times or that have not received at least a threshold number of interactions from online system users. In some embodiments, if various ad requests have similar adjusted bid amounts, the online system 140 identifies 330 one or more ad requests from the ad campaign based at least in part on a number or percentage of targeting criteria of various ad requests satisfied by characteristics of the user of the two ad requests based on a number of characteristics associated with the user satisfying targeting criteria associated with each of the ad requests having similar adjusted bid amounts (e.g., ad requests having at least a threshold number or percentage of targeting criteria satisfied by characteristics of the user).

Using the pacing multiplier associated with the ad campaign, the online system 140 modifies 335 the adjusted bid amounts associated with the identified one or more ad requests. For example, an adjusted bid amount associated with an identified ad request is multiplied by the pacing multiplier to increase or decrease the adjusted bid amount. However, in other embodiments, the adjusted bid amount associated with an identified ad request may be combined with the pacing multiplier using any suitable operation to modify 335 the adjusted bid amount of the ad request. Modifying 335 a bid amount of an ad request using a pacing multiplier is further described in U.S. patent application Ser. No. 13/294,094, filed on Nov. 10, 2011, which is incorporated by reference in its entirety as stated previously.

The identified one or more ad requests and their modified adjusted bid amounts are included 340 in a selection process by the online system 140. The selection process selects content for presentation to the user, such as ad requests for presentation to the user via the identified opportunity. For example, the selection process is an auction based on the modified adjusted bid amounts of the identified ad requests and bid amounts of ad requests from other ad campaigns. In some embodiments, the selection process ranks the identified ad requests from the ad campaign and ad requests from other ad campaigns based on their modified adjusted bid amounts and their bid amounts, respectively. Ad requests having at least a threshold position in the ranking or at least a threshold bid amount or adjusted modified bid amount are selected for presentation to the user.

If the selection process selects 345 an identified ad request from the ad campaign for presentation, the identified ad request is communicated to a client device 110 for presentation to the user. Based on the selection of the identified ad request, the online system 140 modifies 350 the pacing multiplier and one or more of the bid adjustment values to reflect the impression of the selected identified ad request or interaction with the identified selected ad request.

Based at least in part on the selection of the identified ad request, the interval impression objective, and the budget, the pacing multiplier and one or more of the bid adjustment values are modified 350. The online system 140 modifies 350 the pacing multiplier and the bid adjustments at different rates to allow presentation of various ad requests from the ad campaign while completing the ad campaign objective without exceeding the budget. In various embodiments, the online system 140 modifies 350 the pacing multiplier more frequently than the one or more bid adjustments. For example, the online system 140 modifies 350 the pacing multiplier after each impression of an ad request from the ad campaign or each interaction with a presented ad request from the ad campaign and modifies 350 the one or more bid adjustments after a threshold number of impressions of ad requests from the ad campaign or after a threshold number of interactions with ad requests from the ad campaign are received. The online system 140 modifies 350 the pacing multiplier based on the objective, the time interval, and a number of impressions or interactions with ad requests from the ad campaign to satisfy the objective without exceeding the budget, as further described in U.S. patent application Ser. No. 13/294,094, filed on Nov. 10, 2011, which is incorporated by reference in its entirety.

A bid adjustment value of the selected identified ad request is modified 350 to reflect presentation of the selected identified ad request or interaction with the selected identified ad request. For example, the bid adjustment value of the selected identified ad request is decreased after a threshold number of impressions of the selected identified ad request or after a threshold number of interactions with the selected identified ad request to decrease the modification of the selected identified ad request's bid amount as the ad request receives more interactions or impressions. Modification of the bid adjustment of the selected identified ad request is further described above. Additionally, the bid adjustment associated with the selected identified ad request may be further decreased if the user does not interact with the ad request after being presented with the ad request, if the user hides the ad request from view, or if the user performs any other suitable action indicating a lack of preference for the ad request.

Bid adjustments associated with other ad requests in the ad campaign including the selected identified ad request may also be modified 350 based on presentation of the selected identified ad request to the user. For example, the bid adjustment of an additional ad request in the ad campaign including the selected identified ad request may be normalized based on a total number of impressions of or interactions with the additional ad request and the selected identified ad request. Additionally, the online system 140 may also receive an instruction from the advertiser providing the ad campaign to cease modification of bid amount associated with one or more ad requests in the ad campaign using bid adjustment values after a threshold number of impressions of or a threshold number of interactions with an ad request in the ad campaign or with the ad campaign have been received.

### Modifying Bid Adjustments and a Pacing Multiplier Based on Selection of Ad Requests

FIG. 4 is a process flow diagram of modifying bid amounts of advertisement requests in an advertisement campaign based on selection of the advertisement requests for presentation to online system users. As described above in conjunction with FIG. 3, a bid amount modification process 410 modifies bid amounts of ad requests included in an ad campaign. Ad requests from the ad campaign are communicated 415 to a selection process 420, which identifies ad requests 425 for presentation to an online system user based at least in part on their bid amounts. In various embodiments, the selection process 420 modifies bid amounts of ad requests in the ad campaign based on information associated with the ad campaign by an advertiser. For example, the advertiser requests presentation of multiple ad requests from the ad campaign over time so each of the multiple ad requests is presented an equal number of times during a time interval. Additionally, the advertiser associates a budget with the ad campaign to specify a maximum amount of compensation the advertiser will provide the online system 140 during the time interval for presentation of ad requests from the ad campaign. As described above in conjunction with FIG. 3, the online system 140 determines bid adjustments for various ad requests in the ad campaign and modifies bid amounts associated with the various ad requests based on the bid adjustments to increase or decrease likelihood of selecting ad requests from the ad campaign. For example, the online system 140 determines bid adjustments that increase bid amounts of an ad request that has been presented less than a threshold number of times or of an ad request that has been presented a number of times so that a difference between the number of times the ad request has been presented and a number of times an additional ad request in the ad campaign has been presented equals or exceeds a threshold amount. As the online system 140 selects ad request from the ad campaign to communicate 415 to the selection process 420 based on the ad requests' bid amounts, the bid modifier allows the online system 140 to increase or decrease likelihoods of communicating 415 various ad requests from the ad campaign to the selection process 420 by increasing or decreasing bid amounts of various ad requests in the ad campaign.

As ad requests 425 from the ad campaign are selected for presentation to users by the selection process 420, the bid adjustments for various ad requests are modified 412 based on information 430 A received from the selection process 420. Without modifying 412 the bid adjustments based on the selection process, adjustments to the bid amounts of ad requests in the ad campaign may cause a disproportionate number of certain ad requests to be communicated 415 from the ad campaign to the selection process 420. Accordingly, results of the selection process, or other information 430 A describing the selection process, is communicated to the bid amount modification process 410, which modifies 412 bid amounts of various ad requests to increase the diversity of ad requests communicated 415 from the ad campaign to the selection process 420. For example, after an ad request has been selected for presentation by the selection process 420 or has been communicated to users a threshold number of times, the bid amount modification process 410 reduces the bid adjustment for the ad request or modifies the bid adjustment for the ad request to decrease the bid amount for the ad request.

Additionally, the bid amount modification process 410 applies a pacing multiplier to bid amounts of ad requests from the ad campaign to modify the bid amounts so the budget for the ad campaign is not exhausted before the time interval associated with the ad campaign. For example, based on the time remaining in the time interval, an objective for the ad campaign, and an amount remaining in the budget, the bid amount modification process 410 determines a pacing multiplier that modifies bid amounts of ad requests in the ad campaign. Hence, modifying the pacing multiplier allows the bid amount modification process 410 to select advertisements from the ad campaign so the objective is completed during the time interval without exceeding the budget. As ad requests 425 from the ad campaign are selected for presentation to users by the selection process 420, information 430B from the selection process 420 is communicated to the bid amount modification process 410, which modifies the pacing multiplier based on information 430 B from the selection process 420. For example, the selection process 420 indicates when an ad request from the ad campaign was selected, was presented to a user, or received a specified type of interaction from a user to the bid amount modification process 410.

To allow presentation of various ad creative from the ad campaign and to complete the objective of the ad campaign during the time interval and subject to the budget, the bid amount modification process 410 modifies 412 the bid adjustments and modifies 414 the pacing multiplier at different rates. In various embodiments, the bid amount modification process 410 modifies 414 the pacing multiplier more frequently than the bid adjustments are modified 412. For example, the bid amount modification process 410 modifies 414 the pacing multiplier after each presentation of ad requests from the ad campaign or after each interaction with an ad request from the ad campaign, while modifying 412 the bid adjustments after an ad request from the ad campaign is presented a threshold number of times or receives a threshold number of interactions from users when it is presented. Alternatively, the bid amount modification process 410 modifies 412 one of more of the bid adjustments when certain ad requests from the ad campaign (e.g., ad requests in a set of ad requests specified by the advertiser) are presented or receive interactions from users and modifies 414 the pacing multiplier when any ad request from the ad campaign is presented or receives an interaction when presented. In various embodiments, an advertiser providing the ad campaign to the online system 140 specifies criteria for modifying 412 one or more of the bid adjustments and for modifying 414 the pacing multiplier.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information for an advertising campaign (“ad campaign”) including one or more advertisement requests (“ad requests”) for presentation to one or more users of an online system, the information specifying a budget for the ad campaign, bid amounts associated with ad requests included in the ad campaign;
identifying an objective associated with the ad campaign specifying a number of interactions associated with ad requests included in the ad campaign during a time interval;
determining bid adjustments associated with different ad requests included in the ad campaign, a bid adjustment associated with an ad request based at least in part on interaction with the ad request by users of the online system presented with the ad request;
determining a pacing multiplier associated with the ad campaign based at least in part on a number of users of the online system previously presented with at least one ad request included in the ad campaign, the objective, and the budget for the ad campaign;
adjusting bid amounts of ad requests included in the ad campaign based on the bid adjustments, a bid amount associated with the ad request modified by the bid adjustments associated with the ad request;
identifying one or more ad requests from the ad campaign based at least in part on the adjusted bid amounts responsive to identifying an opportunity to present advertisement content to a user of the online system;
modifying the adjusted bid amounts associated with the identified one or more ad requests based at least in part on the pacing multiplier associated with the ad campaign;
including the identified one or more ad requests and the modified adjusted bid amounts associated with the identified one or more ad requests in a selection process;
selecting an identified ad request for presentation to the user via a client device; and
modifying the pacing multiplier and one or more of the bid adjustments based at least in part on the selection of the identified ad request, the interval impression objective, and the budget, where the pacing multiplier and the one or more bid adjustments are modified at different rates.

2. The method of claim 1, wherein modifying the pacing multiplier and one or more of the bid adjustments based at least in part on the selection of the identified ad request, the interval impression objective, and the budget, the pacing multiplier modified more frequently than the one or more bid adjustments comprises:
modifying the pacing multiplier in response to presentation of the identified ad request; and
modifying one or more bid adjustments in response to presentation of the identified ad request a threshold number of times.

3. The method of claim 1, wherein modifying the pacing multiplier and one or more of the bid adjustments based at least in part on the selection of the identified ad request, the interval impression objective, and the budget comprises:
modifying the pacing multiplier in response to receiving an indication of an interaction with the identified ad request; and
modifying one or more bid adjustments in response to receiving an indication of a threshold number of interactions with the identified ad request.

4. The method of claim 1, wherein modifying the pacing multiplier and one or more of the bid adjustments based at least in part on the selection of the identified ad request, the interval impression objective, and the budget comprises:
modifying the pacing multiplier in response to presentation of the identified ad request;
determining the identified ad request is included in a set of ad requests from the ad campaign; and
modifying one or more bid adjustments based on the determining.

5. The method of claim 1, wherein modifying the pacing multiplier and one or more of the bid adjustments based at least in part on the selection of the identified ad request, the interval impression objective, and the budget comprises:
modifying the pacing multiplier in response to receiving a description of an interaction with the identified ad request;
determining the identified ad request is included in a set of ad requests from the ad campaign; and
modifying one or more bid adjustments based on the determining.

6. The method of claim 1, wherein the objective associated with the ad campaign specifies one or more selected from a group consisting of: a number of impressions of ad requests in the ad campaign, a number of a specific type of interaction with ad requests in the ad campaign, a number of interactions with objects associated with one or more ad requests in the ad campaign, and an y combination thereof

7. The method of claim 1, wherein a bid adjustment associated with an ad request included in the ad campaign is based at least in part on a number of impressions of the ad request.

8. The method of claim 7, wherein the bid adjustment associated with the ad request included in the ad campaign is inversely proportional to the number of impressions of the ad request.

9. The method of claim 7, wherein the bid adjustment associated with the ad request included in the ad campaign is also based at least in part on a number of interactions with the ad request by users of the online system.

10. The method of claim 9, wherein the bid adjustment associated with the ad request included in the ad campaign is inversely proportional to the number of interactions with the ad request by users of the online system.

11. A method comprising:
receiving information for an advertising campaign (“ad campaign”) including one or more advertisement requests (“ad requests”) for presentation to one or more users of an online system, the information specifying a budget for the ad campaign, bid amounts associated with ad requests included in the ad campaign;
identifying an objective associated with the ad campaign specifying a number of impressions for each ad request included in the ad campaign during a time interval;
determining bid adjustment values associated with different ad requests included in the ad campaign, a bid adjustment value associated with an ad request based at least in part on interaction with the ad request by users of the online system presented with the ad request;
determining a pacing multiplier associated with the ad campaign based at least in part on a number of users of the online system previously presented with at least one ad request included in the ad campaign, the objective, and the budget for the ad campaign;
determining bid amounts for one or more ad requests in the ad campaign based at least in part on the bid adjustment values and the pacing multiplier;
including ad requests associated with the determined bid amounts from the ad campaign in one or more selection processes for presentation to users of the online system; and
modifying the pacing multiplier and one or more of the bid adjustments based at least in part on presentation of ad requests from the ad campaign to one or more users of the online system, the pacing multiplier modified more frequently than the one or more bid adjustments.

12. The method of claim 11, wherein modifying the pacing multiplier and one or more of the bid adjustments based at least in part on presentation of ad requests from the ad campaign to one or more users of the online system comprises:
modifying the pacing multiplier in response to presentation of ad requests from the ad campaign; and
modifying one or more bid adjustments in response to presentation of ad request from the ad campaign a threshold number of times.

13. The method of claim 11, wherein modifying the pacing multiplier and one or more of the bid adjustments based at least in part on presentation of ad requests from the ad campaign to one or more users of the online system comprises:
modifying the pacing multiplier in response to receiving an indication of an interaction with an ad request from the ad campaign; and
modifying one or more bid adjustments in response to receiving an indication of a threshold number of interactions with an ad request from the ad campaign.

14. The method of claim 11, wherein modifying the pacing multiplier and one or more of the bid adjustments based at least in part on presentation of ad requests from the ad campaign to one or more users of the online system comprises:
modifying the pacing multiplier in response to presentation of ad requests from the ad campaign;
determining an ad request from the ad campaign presented to one or more online system users is included in a set of ad requests from the ad campaign; and
modifying one or more bid adjustments based on the determining.

15. The method of claim 1, wherein modifying the pacing multiplier and one or more of the bid adjustments based at least in part on presentation of ad requests from the ad campaign to one or more users of the online system comprises:
modifying the pacing multiplier in response to receiving a description of an interaction with a presented ad request from the ad campaign;
determining the presented ad request is included in a set of ad requests from the ad campaign; and
modifying one or more bid adjustments based on the determining.

16. A computer program product comprising a computer readable storage medium having instructions encoded thereon that, when executed by a processor, cause the processor to:
receive information for an advertising campaign (“ad campaign”) including one or more advertisement requests (“ad requests”) for presentation to one or more users of an online system, the information specifying a budget for the ad campaign, bid amounts associated with ad requests included in the ad campaign;
identify an objective associated with the ad campaign specifying a number of impressions for each ad request included in the ad campaign during a time interval;
determine bid adjustment values associated with different ad requests included in the ad campaign, a bid adjustment value associated with an ad request based at least in part on interaction with the ad request by users of the online system presented with the ad request;
determine a pacing multiplier associated with the ad campaign based at least in part on a number of users of the online system previously presented with at least one ad request included in the ad campaign, the objective, and the budget for the ad campaign;
determine bid amounts for one or more ad requests in the ad campaign based at least in part on the bid adjustment values and the pacing multiplier;
include ad requests associated with the determined bid amounts from the ad campaign in one or more selection processes for presentation to users of the online system; and
modify the pacing multiplier and one or more of the bid adjustments based at least in part on presentation of ad requests from the ad campaign to one or more users of the online system, the pacing multiplier modified more frequently than the one or more bid adjustments.

17. The computer program product of claim 16, wherein modify the pacing multiplier and one or more of the bid adjustments based at least in part on presentation of ad requests from the ad campaign to one or more users of the online system comprises:
modify the pacing multiplier in response to presentation of ad requests from the ad campaign; and
modify one or more bid adjustments in response to presentation of ad request from the ad campaign a threshold number of times.

18. The computer program product of claim 16, wherein modify the pacing multiplier and one or more of the bid adjustments based at least in part on presentation of ad requests from the ad campaign to one or more users of the online system comprises:
modify the pacing multiplier in response to receiving an indication of an interaction with an ad request from the ad campaign; and
modify one or more bid adjustments in response to receiving an indication of a threshold number of interactions with an ad request from the ad campaign.

19. The computer program product of claim 16, wherein modify the pacing multiplier and one or more of the bid adjustments based at least in part on presentation of ad requests from the ad campaign to one or more users of the online system comprises:
modify the pacing multiplier in response to presentation of ad requests from the ad campaign;
determine an ad request from the ad campaign presented to one or more online system users is included in a set of ad requests from the ad campaign; and
modify one or more bid adjustments based on the determining.

20. The computer program product of claim 16, wherein modify the pacing multiplier and one or more of the bid adjustments based at least in part on presentation of ad requests from the ad campaign to one or more users of the online system comprises:
modify the pacing multiplier in response to receiving a description of an interaction with a presented ad request from the ad campaign;
determine the presented ad request is included in a set of ad requests from the ad campaign; and
modify one or more bid adjustments based on the determining.
